(19) United States
(12) Patent Application Publication
(10) Pub. No.: US 2014/0043371 A1
(43) Pub. Date: Feb. 13, 2014

(54) DISPLAY CONTROL FOR MULTI-PRIMARY DISPLAY

(71) Applicants: Erno Hermanus Antonius Langendijk, Eindhoven (NL); Karel Johannes Gerhardus Hinnen, Eindhoven (NL); Michiel Adriaanszoon Klompenhouwer, Waalre (NL)

(72) Inventors: Erno Hermanus Antonius Langendijk, Eindhoven (NL); Karel Johannes Gerhardus Hinnen, Eindhoven (NL); Michiel Adriaanszoon Klompenhouwer, Waalre (NL)

(21) Appl. No.: 13/641,455

(22) PCT Filed: Apr. 11, 2011
(86) PCT No.: PCT/IB11/51544

§ 371 Date: Sep. 20, 2013

(30) Foreign Application Priority Data
Apr. 15, 2010 (EP) 10159989.2

(51) Int. Cl. G09G 3/36

(52) U.S. Cl. CPC G09G 3/3607
USPC 345/690; 345/88

(57) ABSTRACT

A controller for a multi-primary display having M>3 primaries receives a set of input N-primary image color defining values comprising drive values for N primaries for each pixel. A compensator (317) generates a set of compensated N-primary image color (N>=3) defining values by applying a luminance compensation to the values of the set of input N-primary image color defining values where the luminance compensation for each pixel depends on the chromaticity of the pixel. A backlight processor (311) determines backlight levels in response to the compensated N-primary image color defining values. A modifier (313) then generates modified N-primary image color defining values by adjusting the input or the modified N-primary image color defining values or the for the backlight level and a primary converter (315) converts the modified N-primary image color defining values into multi-primary drive values for the display. The approach may e.g. reduce clipping for multi-primary displays with dynamic backlight control by introducing a low complexity pre-processing luminance compensation to existing equipment.

### FIELD OF THE INVENTION

The invention relates to display control for a multi-primary display and in particular to driving of a multi-primary display from a three-primary display input signal.

### BACKGROUND OF THE INVENTION

Light modulating displays (such as Liquid Crystal Displays (LCDs)) have become increasingly popular in recent years and are now the most common display type for electronic displays. In light modulating displays a light source radiates light which is incident on a layer of transmissive (or reflective) pixels that can attenuate (modulate) the light to a degree which can be controlled by an electrical signal. Typically the light source is referred to as a backlight.

Thus, many display panels comprise a light unit providing a backlight for illuminating variable light transfer pixels of a pixilated display panel. Usually, the pixilated display is a matrix display. Typically, the backlight provides a non-varying light spectrum (i.e. a white backlight, although also multicolored backlights are possible, e.g. blue/yellow) and the input image is reproduced by modulating the optical state of the pixels such that the light transmission is modified to provide the desired intensity (or color subpixel intensities) for the pixel.

Backlight sources have conventionally predominantly been provided by the use of fluorescent lamps. However, Light Emitting Diodes (LED's) have also been proposed for backlights. LEDs can provide almost monochromatic spectra and LED backlights can be used to provide a multi-colored backlight.

A known transmissive display is the Liquid Crystal Display (LCD) which comprises pixels made of liquid crystal material for which the optical transmission can be controlled electrically in accordance with the image to be displayed. Another display component which modulates light from a lighting source which may itself be variable is a Digital Mirror device (DMD), typically usable in digital cinema, where dimming may be useful, both from an energy saving and rendering quality point of view. Transflective displays, which partly reflect and partly transmit light from the light sources, are also known.

In a color display device, each one of the pixels comprises sub-pixels and associated color filters to obtain different colors that together provide the color of the pixel in accordance with the image to be displayed. The colored lights that leave the color filters and illuminate the associated sub-pixels are referred to as the primary colors (or just primaries) of the color display device. These primary colors define the color gamut that the display device can display.

Traditionally, color display devices have used three-primary colors, such as typically Red (R), Green (G) and Blue (B). As a consequence, input images are typically defined in a three-component color space, which usually is the RGB color space or a thereto related color space.

Conventional backlight displays tend to be based on a fixed backlight being modulated by the controllable pixels. However, in recent years, displays that use a dynamic backlight control have become increasingly popular. In such displays, the backlight level may be reduced for darker images and increased for lighter images. Furthermore, more advanced displays use a local backlight control where the display is divided into a plurality of backlight segments for which the backlight level may be set individually based on the image characteristics for the corresponding image segment.

The dynamic backlight control may substantially improve the dynamic range and contrast of the generated image and may further reduce the power consumption of the display. However, a critical problem is that of how to control the backlight.

An example of a display system using dynamic backlight control in accordance with prior art is shown in FIG. 1. In the example, a backlight 101 provides backlight for a display panel 103 that modulates it to provide the desired front of screen image. The backlight is divided into a plurality of backlight sources that are arranged spatially across the display and which can be controlled individually. The display is accordingly divided into a plurality of image segments corresponding to the different backlight sources.

The display system receives an RGB signal which is fed to a first block 101 that determines the minimum backlight for each individual backlight source such that the backlight is sufficiently strong to not result in any clipping in the corresponding image segment, i.e. the backlight is set such that the highest drive value in the segment can be represented if the corresponding controllable transmissive element of the display panel 103 is fully open. Specifically, the first block 101 divides the input image into blocks/segments that correspond to the backlight sources. For each block of input pixels the maximum drive value is determined for all pixels in the block and for both the Red, Green, and Blue channels. This drive value determines the drive value of the backlight source for the block/segment and this is set to a level that results in the desired front of screen luminance for that drive value when the corresponding transmissive (subpixel) element is fully open.

The first block 105 controls the backlight 101 and the drive values for the backlight 101 are further fed to a second block 107 which for each pixel determines the total amount of light reaching it from the backlight. In practical applications, this typically includes light from several backlight sources.

The system further comprises a third block 109 which receives the input RGB drive values and the backlight values determined by the second block 107. It then proceeds to generate drive values for the transmissive elements of the display panel 103 by compensating the original drive values for the reduced incident backlight calculated by the second block 107.

Recently, so called multi-primary displays have been introduced which use more than three-primary colors. These output primaries with different spectra—typically of lesser hue width than RGB displays, in which each primary roughly covers a third of the visual hue—are made by a multiplicative combination of the local backlight spectrum and the local pixel filter transmission, i.e. they may be made from a white light source by using several color filters, or without filters with several e.g. time sequential chromatic illuminations, or by a combination of those. It should be noted that the term “colors” is used as a convenient term for output primaries with different spectra that are not necessarily (but may be) substantially monochromatic, or at least of a narrow bandwidth. Such displays are also referred to as wide gamut displays because a wider color gamut can be displayed by using at least four instead of three-primary colors (one can cover by a tent-shaped gamut as shown below 3-dimensional renderable colors from a number of output primaries, which span a polygon in the chromaticity plane).

An example of a multi-primary display employing dynamic backlight may be found in WO2007/135642.

One advantage of the additional primaries is that these may have a higher transmission resulting in such displays typically being brighter and/or more efficient. Also, the primaries can be made more saturated without loss of efficiency, and the gamut area can be designed with more freedom than with RGB, thereby enabling a wider gamut.

As most display signals are provided in conventional three-primary formats, such as RGB formats, multi-primary displays typically include a conversion function for converting the three input drive signals into the drive signals for the four or more primaries.

Combining such multi-primary displays with dynamic backlight is highly desirable. In order to allow reuse of functionality from three-primary displays, the conversion from three-primaries to multi-primary drive signals is typically performed at the input to the display. This is for the example of FIG. 1 illustrated in FIG. 2 where a conversion block 201 is inserted between the third block 109 and the display panel 103 of FIG. 1.

Several solutions exist to find the drive values of the multi-primaries which will produce the desired color as indicated by the input RGB signal. Typically these solutions scale the input and output gamut to the same value. In that case there are colors outside the multi-primary gamut that cannot be reproduced, especially for the bright and saturated red, green, and blue primary colors. One can clip these colors to the boundary of the multi-primary display or use more advanced gamut mapping algorithms that minimize the clipping artifacts.

In the case of input images with dark and saturated colors, it is possible that all pixels can fall within the display gamut, but due to the typical local dimming algorithm which is designed for the RGB displays, the compensated RGB values generated by the third block 109 may fall outside the multi-primary gamut. Hence, clipping is introduced by the dynamic backlight control being combined with the multi-primary display. In particular, whereas the RGB based approach may avoid clipping in an RGB display, it may result in the generation of compensated RGB values that will be clipped when converted to the multi-primary values. Specifically, the approach may result in the backlight being dimmed more than it should for a multi-primary display.

For example, in the case of a backlight with one segment and an input image with a red gray ramp from (R, G, B)=(0, 0, 0) to (R, G, B)=(128, 0, 0) (assuming the values are 8 bit values in the interval [0,255]), the first block 105 will determine that the backlight level should be halved as this can be compensated by doubling the drive value of the input by block 107. However, in a multi-primary display, the light transmission capability of the Red subpixel will be significantly lower than in an RGB display. E.g. for a six primary display, the area of each sub-pixel is only half as that of a sub-pixel of a corresponding three-primary display. Thus, typically, the individual Red sub-pixel of a six primary display will have a maximum light transmission which is around half that of the three-primary display. Thus, in order to provide light corresponding to the drive value of 128, it is necessary to have full backlight. In the specific example, the red grey ramp will be clipped for all drive values above 64 (128/2) despite the multi-primary display being able to represent values up to 128 if the backlight had not been dimmed.

Hence, an improved display system would be advantageous and in particular a system allowing for increased flexibility, reduced clipping, improved reusability of functionality, facilitated implementation, reduced complexity and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an controller for a multi-primary display employing M>3 primaries, the controller comprising: a receiver (309) for receiving a first picture signal comprising a set of input N-primary image color defining values, with N>=3, for a segment of the multi-primary display, from which set of N-primary image color defining values M drive values for M primaries for each pixel of the segment can be derived; a compensator (317) for generating a set of compensated N-primary image color defining values for the segment by applying a luminance compensation to the values of the set of input N-primary image color defining values, the luminance compensation for each pixel of the segment being dependent on a chromaticity of the pixel; a backlight processor (311) for determining a backlight level for the segment of the display in response to the set of compensated N-primary image color defining values; a modifier (313) for generating a set of modified N-primary image color defining values by adjusting at least one of the set of input N-primary image color defining values and the set of compensated N-primary image color defining values for the backlight level; and a primary converter (315) for converting the set of modified N-primary image color defining values into a set of M-primary drive values for the M primaries and generating a M-primary drive signal for the multi-primary display comprising the set of M-primary drive values.

The invention may provide improved display control. In particular, embodiments of the invention may reuse functionality for backlight control for N-primary displays (and specifically three-primary displays) and/or multi-primary conversion (to M primaries) functionality while providing improved backlight control. The approach may specifically in many embodiments reduce clipping artifacts. Typically, low complexity and/or reduced cost may be achieved. In particular, improved backwards compatibility may be achieved.

The invention may in many embodiments allow a simply pre-processing of the received N-primary image color defining values to reduce the clipping introduced when converting N-primary image color defining values to M-primary drive signals where M>N. The input image defined with the N-primary image color defining values will e.g. typically be defined in a standard RGB space (as e.g. in AVC), an extended RGB space, or a virtual primary space (e.g. XYZ), in which case it is three primary input, but it may also already be multi-primary input, e.g. it may contain additional regional data in a yellow primary channel for encoding a yellow object in the scene. In all cases however, according to standard colorimetrics, this input data can be converted into other color reproductions, e.g. Luv, Lab, etc. The approach may in many embodiments simply allow a low complexity pre-processing functionality to be added to an existing multi-primary dynamic backlight controller to provide improved performance and in particular reduced clipping.

The luminance compensation may be any compensation that results in a modified luminance for at least some chromaticity values (i.e. a region of the color space); and of course changes may be different in time and space, such as different pre-compensation per shot or scene, or per region of the image [e.g. in a dark shadowy area clipping errors may be less objectionable than in the sky].

The N-primary image color defining values may specifically be RGB values. The multi-primary display may for example be a six primary display and may specifically be an RGBYMC display with a Red, Green, Blue, Yellow, Magenta, and Cyan primary (i.e. its driving value color description will be 6 dimensional).

Typically, the pre-compensation will be specified for a particular multi-primary display in the display factory during display manufacturing, e.g. by preloading Look Up Table (LUT) data in a generic blank LUT in a video processing IC for driving the display.

However, it may also be advantageous if a creative artist (e.g. a color grader in Hollywood) may also have some saying in the final video processing (e.g. he may want to do so when he is already grading the video for full color effects on that multi-primary, e.g. by recoloring a yellow banana). He may then specify and check a few pre-compensation behaviors for at least one such multi-primary display. E.g., he may want a saying in only one critical scene in a movie, e.g. a dark horror scene, in which the backlight is dimmable a lot, but clipping errors may be very visible for the human eye. He may add this information in an additional information part (such as a SEI message [Supplemental Enhancement Information]) for a Hollywood quality mode, and the television, may then apply this pre-compensation data, rather than e.g. the one standard available, preloaded in the factory.

In accordance with an optional feature of the invention, the luminance compensation is predetermined for each chromaticity value.

The luminance compensation may be a predetermined function of the chromaticity value for the pixel. In particular, a static relation between a chromaticity value and a luminance compensation may be used (e.g. one can use a suboptimal value, which is always reasonably right, may deteriorate certain pictures as to visual quality more than optimally required, but always works because it is designed depending mostly on the static properties of the display, and not the actual picture content; in that case there may be problematic gamut regions which are over-compensated for, although they are less psychovisually relevant in the current images, i.e. a smarter content-dependent algorithm may do even better). The relation may in many embodiments be dependent only on the chromaticity value and/or may be independent of the luminance. For each pixel, the chromaticity may thus be determined and a predetermined luminance compensation for that chromaticity may be applied.

The approach may provide a low complexity and/or low resource demanding application. In particular, the approach may allow a function to be determined and implemented during the design/manufacturing phase, and the controller may be implemented without functionality or means for dynamic modifications of the function.

In accordance with an optional feature of the invention, the compensator (317) is arranged to convert input N-primary image color defining values for pixels of the segment into two chromaticity values and to determine the luminance compensation for the pixel in response to the two chromaticity values.

This may provide a particular advantageous approach in many embodiments. In particular, it may allow an efficient implementation of the determination of the luminance compensation as only two input parameters are used. This may in many embodiments allow a more compact implementation, e.g. a smaller look-up-table implementing the function for determining the luminance compensation may be used.

In accordance with an optional feature of the invention, the compensator (317) comprises a two-dimensional look up table relating values of the two chromaticity values to a luminance compensation.

This may allow a highly efficient and low cost/complexity implementation. A compact look up table may typically be achieved.

The feature may allow improved and/or facilitated operation and/or implementation in many embodiments. E.g. in many scenarios it may be advantageous to reduce computational requirements at the expense of memory requirements.

In accordance with an optional feature of the invention, the compensator (317) is arranged to determine the luminance compensation for a pixel by calculating a mathematical formula defining the luminance compensation as a function of the compensated N-primary image color defining values for the pixel.

This may allow improved and/or facilitated operation and/or implementation in many embodiments. E.g. in many scenarios it may be advantageous to reduce memory requirements at the expense of computational requirements. In many scenarios, an accurate determination of the appropriate luminance compensation may be achieved by evaluating a mathematical formula that requires only a low computational resource. The approach may further allow a faster determination in many embodiments and may avoid the need for calculating an explicit chromaticity value.

In accordance with an optional feature of the invention, the compensation value for a chromaticity value is dependent on a maximum renderable luminance for the chromaticity value in the gamut of the N primaries relative to a maximum renderable luminance for the chromaticity value in the gamut of the M primaries.

This may allow a particularly efficient pre-compensation that accurately reflects the typical properties of the multi-primary conversion that result in clipping. The maximum luminances may be normalized luminances relative to a maximum or nominal light output for the display.

In accordance with an optional feature of the invention, the compensation value for a chromaticity value is substantially the ratio between a maximum luminance for the chromaticity in the gamut of the N-primaries and a maximum luminance for the chromaticity in the gamut of the M primaries.

This may allow a particularly efficient pre-compensation that accurately reflects the typical properties of the multi-primary conversion and display that result in clipping. A luminance compensation factor may simply be determined as:

f(x,y)=Y_{multi-primary}(x,y)/Y_{three-primary}(x,y),

where Y_{three-primary} (x,y) is the normalized maximum luminance of the three-primary display for a chrominance represented by x, y and Y_{multi-primary} (x,y) is the normalized maximum luminance of the multi-primary display for a chromaticity represented by x, y (or similar corrections, whether explicit tables or geometric shapes with equations can be defined over other chroma plane definitions, like e.g. hue saturation, (a,b), non-linear pseudo-chroma spaces like chrominance, etc.). The compensated N-primary image color defining values may be generated by multiplying the input N-primary image color defining value by f(x,y). This function may be designed (predesigned for a type of display, or on-the-fly) based on criteria such as the maximum or tunable gamut of the particular multi-primary display versus a standard display (such as a standardized RGB space), or versus the gamut spanning expectable image content of certain properties (e.g. film or sport materials), or biased taking any such geometrical or statistical measurements into account (also e.g. how severe errors such as clipping would be in particular cases).

Note that by using the mathematical relationships between two-dimensional chromaticity plane-defined color representations, and three-dimensional color space definitions (like linear RGB, or non-linear YCrCb), operations which we will below mainly describe as luminance modifying, can explicitly modify the luminance with an equation, or implicitly do so by applying a function in the three-dimensional space, e.g. a proportional scaling in linear RGB, or another function in a nonlinear space, which at least approximates a desired luminance modification, or at least realizes a luminance reduction, which leads to better renderability on the M-primary display.

The above equation may be particularly appropriate for the example where the input is coded as a three primary signal corresponding to the three primary display. For more general applications, it may be desirable to replace the denominator by a value reflecting the actual requirement of the input gamut.

In accordance with an optional feature of the invention, the compensator (317) is arranged to increase luminance for at least some chromaticities.

This may allow improved performance by mitigating clipping effects due to the multi-primary conversion. In particular, it may allow a pre-compensation to allow a three-primary backlight dimming to take into account lower light transmissitivity characteristics of multi-primary subpixels.

In accordance with an optional feature of the invention, all primaries of the M primaries are chromatic primaries.

This may provide improved performance and/or facilitated implementation and/or operation in many embodiments.

In accordance with an optional feature of the invention, the backlight processor (311) is arranged to determine the backlight level in response to a maximum drive level of the set of compensated N-primary image color defining values.

This may provide improved performance and/or facilitated implementation and/or operation in many embodiments.

In accordance with an optional feature of the invention, the controller further comprises means (401) for determining an incident backlight level for each pixel of the segment in response to the backlight level and backlight levels of other segments, and wherein the modifier (313) is arranged to generate the set of modified N-primary image color defining values by adjusting drive values of the set of input N-primary image color defining values for each pixel in response to the incident backlight level for the pixel.

This may provide improved performance and/or facilitated implementation and/or operation in many embodiments.

In accordance with an optional feature of the invention, the modifier (313) is arranged to generate the set of modified N-primary image color defining values by adjusting the set of input N-primary image color defining values for the backlight level.

This may provide a practical implementation in many embodiments. In particular, it may provide improved backwards compatibility and e.g. reuse of existing functionality in many embodiments. In many embodiments, it may allow a reduced complexity implementation.

In accordance with an optional feature of the invention, the modifier (313) is arranged to generate the set of modified N-primary image color defining values by adjusting the set of compensated N-primary image color defining values for the backlight level.

This may provide a practical implementation in many embodiments. In particular, it may provide improved backwards compatibility and e.g. reuse of existing functionality in many embodiments. In many embodiments, it may allow a reduced complexity implementation.

In accordance with an optional feature of the invention, the primary converter (315) further comprising means for compensating at least one of the set of modified three-primary drive values and the set of compensated three-primary drive values for the luminance compensation of the drive values of the set of input three-primary drive values.

This may provide a practical implementation in many embodiments. In particular, it may provide improved backwards compatibility and e.g. reuse of existing functionality in many embodiments.

In accordance with an optional feature of the invention, the luminance compensation corresponds to a scaling of the drive values of the set of input three-primary drive values.

This may provide a practical implementation in many embodiments. In particular, it may allow a reduced complexity implementation.

In accordance with an optional feature of the invention, the controller further comprises: a memory for storing a relation between the chrominance and the luminance compensation; and input means for receiving external data describing relations between chrominance values and luminance compensation values and for storing this in the memory.

This may allow increased flexibility and adaptability. For example, it may allow a generic controller to be manufactured which can then be adapted and customized by for individual display types.

In accordance with an optional feature of the invention, there is provided claim 17.

This may allow a particularly advantageous implementation and/or operation and/or performance. In particular, it may allow the exact image rendering to be controlled by remote means, such as e.g. allow a content provided to specify the backlight control and rendering impact.

In accordance with an optional feature of the invention, there is provided a display system comprising the display controller (303) and the multi-primary display (301).

The invention may provide an improved display system. In some embodiments, the controller and multi-primary display may be implemented in separate units. For example, the display controller may be implemented in a separate cabinet or e.g. in a set-top box.

According to an aspect of the invention there is provided a method of controlling a multi-primary display, the method comprising: specifying at an image creation side of at least one luminance transforming pre-compensation operation for at least one envisaged multi-primary display, and transmitting to a site of the multi-primary display parametric information specifying this pre-compensation information as a metadata signal correlated with the image signal.

This may allow a particularly advantageous implementation and/or operation and/or performance. In particular, it may allow the exact image rendering to be controlled by remote means, such as e.g. allow a content provided to specify the backlight control and rendering impact.

According to an aspect of the invention there is provided a method of controlling a multi-primary display employing M>3 primaries, the method comprising: receiving a first picture signal comprising a set of input N-primary image color defining values, with N>=3, for a segment of the multi-primary display, from which set of N-primary image color defining values M drive values for M primaries for each pixel of the segment can be derived; generating a set of compensated N-primary image color defining values for the segment by applying a luminance compensation to the values of the set of input N-primary image color defining values, the luminance compensation for each pixel of the segment being dependent on a chromaticity of the pixel; determining a backlight level for the segment of the display in response to the set of compensated N-primary image color defining values; generating a set of modified N-primary image color defining values by adjusting at least one of the set of input N-primary image color defining values and the set of compensated N-primary image color defining values for the backlight level; and converting the set of modified N-primary image color defining values into a set of M-primary drive values for the M primaries and generating a M-primary drive signal for the multi-primary display comprising the set of M-primary drive values

According to an aspect of the invention there is provided a controller for a multi-primary display employing M>3 primaries, the controller comprising: a receiver (309) for receiving a first picture signal comprising a set of input N-primary image color defining values, with N>=3, for a segment of the multi-primary display, from which set of N-primary image color defining values M drive values for M primaries for each pixel of the segment can be derived; a first primary converter (701) for converting the set of input N-primary image color defining values into a first set of M-primary drive values for the M primaries; a backlight processor (311) for determining a backlight level for the segment of the display in response to the first set of M primary image color defining values; and a drive processor (313, 315) for generating a set of modified multi-primary drive values for the M primaries in response to the backlight level for the segment and at least one of the set of input N-primary image color defining values and the first set of M primary image color defining values and generating a multi-primary drive signal for the multi-primary display comprising the set of modified multi-primary drive values.

This may provide improved display control. In particular, embodiments of the invention may reuse functionality for backlight control for three-primary displays and/or multi-primary conversion functionality while providing improved backlight control. The approach may specifically in many embodiments reduce clipping artifacts. Typically, low complexity and/or reduced cost may be achieved. In particular, improved backwards compatibility may be provided.

The invention may in many embodiments allow a low complexity pre-conversion of the received N-primary image color defining values to reduce the clipping introduced when converting N-primary image color defining values to multi-primary signals for a dynamic backlight display. The approach may in many embodiments simply allow a low complexity pre-processing functionality to be added to an existing multi-primary dynamic backlight controller to provide improved performance and in particular reduced clipping.

Optionally, the drive processor (313, 315) is arranged to generate the set of modified multi-primary drive values for the M primaries by compensating drive values of the first set of M primary image color defining values for at least the backlight level for the segment.

This may provide improved performance and/or facilitated implementation and/or operation in many embodiments. In particular, it may in many systems allow reduced functionality by using the same three-primary to multi-primary conversion both for determining backlight levels and for driving the display panel.

Optionally, the drive processor (313, 315) is arranged to generate a set of modified N-primary image color defining values by compensating drive values of the set of input N-primary image color defining values for at least the backlight level for the segment, and to generate the set of modified multi-primary drive values for the M primaries by converting drive values of the set of modified N-primary image color defining values to multi-primary drive values for the M primaries.

This may provide improved performance and/or facilitated implementation and/or operation in many embodiments. In particular, it may in many systems allow increased reuse of existing circuitry and may provide improved backwards compatibility.

Optionally, the backlight processor (311) is arranged to determine the backlight level based on values that only include the first set of M primary image color defining values.

This may provide improved performance and/or facilitated implementation and/or operation in many embodiments.

Optionally, the backlight processor (311) is arranged to determine the backlight level in response to a maximum drive level of the first set of M primary image color defining values.

This may provide improved performance and/or facilitated implementation and/or operation in many embodiments.

According to an aspect of the invention there is provided a method of controlling a multi-primary display employing M>3 primaries, the method comprising: receiving a first picture signal comprising a set of input N-primary image color defining values, with N>=3, for a segment of the multi-primary display, from which set of N-primary image color defining values M drive values for M primaries for each pixel of the segment can be derived; converting the set of input N-primary image color defining values into a first set of M-primary drive values for the M primaries; determining a backlight level for the segment of the display in response to the first set of M primary image color defining values; and generating a set of modified multi-primary drive values for the M primaries in response to the backlight level for the segment and at least one of the set of input N-primary image color defining values and the first set of M primary image color defining values and generating a multi-primary drive signal for the multi-primary display comprising the set of modified multi-primary drive values.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of a display system in accordance with prior art;

FIG. 2 is an illustration of a display system in accordance with prior art;

FIG. 3 is an illustration of an example of elements of a display system in accordance with some embodiments of the invention;

FIG. 4 is an illustration of an example of elements of a display system in accordance with some embodiments of the invention;

FIG. 5 is an illustration of an example of elements of a display system in accordance with some embodiments of the invention;

FIG. 6 is an illustration of examples of gamuts for different renderings for a display system in accordance with some embodiments of the invention

FIG. 7 is an illustration of an example of elements of a display system in accordance with some embodiments of the invention; and

FIG. 8 is an illustration of an example of elements of a display system in accordance with some embodiments of the invention.

### DETAILED DESCRIPTION OF SOME EMBODIMENTS OF THE INVENTION

The following description focuses on embodiments of the invention applicable to a multi-primary LCD display panel with M primaries driven by a N-primary input signal where N is an integer of three or more and M is a larger integer than N. The input signal is specifically an RGB signal, i.e. N=3. However, it will be appreciated that the invention is not limited to this application but may be applied to many other displays and input signals.

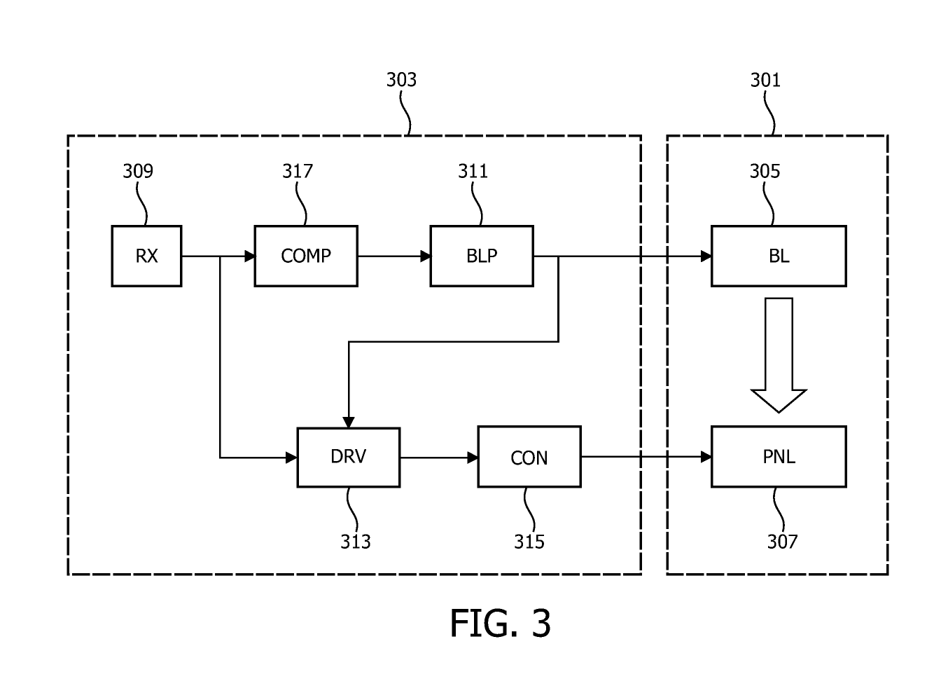

FIG. 3 illustrates an example of a display system in accordance with some embodiments of the invention. The system comprises a display 301 and a display controller 303. The display 301 is a controllable backlight display, and accordingly the display controller 303 generates both a backlight control signal and a pixel drive signal which are fed to the display panel.

The display panel 301 comprises a backlight 305 which emits light that reaches a display panel 307 where the individual (sub)pixels provide a controllable attenuation/transmission of the backlight. It will be appreciated that for brevity and clarity only the parts of the display 301 necessary for the description of the embodiments of the invention are included and that practical displays may further comprise diffusers, polarizers, coating layers, etc as will be well known to the skilled person.

In the example, the backlight is divided into a plurality of backlight (light) sources that can be individually controlled. Thus, a plurality of spatially separated and individually controllable backlight sources is used. The incident backlight on the different areas of the screen may be varied by controlling the backlight level for each backlight source. Each backlight source is associated with a display segment. For example, the display panel 307 may be divided into segments of pixels corresponding to the set of pixels being closest to a given backlight segment light source. Thus, a segment of the display may be an image segment associated with a backlight light source. It will be appreciated that way of dividing the image pixels into segments may be used. However, in many embodiments each segment may comprise the pixels for which the associated backlight source is considered the strongest.

It will be appreciated that the described principle may also be applied to a single controllable backlight source and that this essentially corresponds to there being only a single segment.

In the following, the description will focus on an example where the backlight is a substantially white backlight, i.e. where the light generated by the backlight does not provide any coloration.

In the example, the display panel 307 is a multi-primary panel, i.e. the panel uses M primaries to generate a color image where M is higher than 3. The display panel may for example in addition to RGB primary colors further employ a white primary, or a yellow and cyan primary, or a yellow, magenta and cyan primary etc. Thus, the display may e.g. be an RGBW, an RGBY, RGBCY or RGBYMC display but it will be appreciated that the approach is equally applicable to displays using other primaries and that the primaries do not need to include RGB primaries.

Thus, whereas a typical three-primary display, such as an RGB display, comprises three colored subpixels for each pixel, the display of FIG. 3 comprises at least four subpixels corresponding to the M primaries. In the specific example described in the following, all the primaries are chromatic primaries and thus represent a color rather than provide a white (non-color) spectrum. In the specific example, the display panel 307 is an RGBYMC display.

Due to the larger number of subpixels for each pixel, the area of each subpixel is reduced for a multi-primary display (the term multi-primary display is used to denote the display with M primaries where M>3 and M>N) relative to an N or in the specific example three-primary display (for the same display size and pixel resolution). As a result, the maximum light throughput of each subpixel is reduced relative to a three-primary display and also relative to the maximum pixel transmissitivity/light throughput. As a result some colors may be clipped in the output multi-primary gamut that were not clipped in the original three-primary gamut. For example, for a deep saturated red where all drive signals apart from the red primary are zero, the light throughput for the pixel is halved relative to the three-primary display. Thus clipping may be exacerbated if the dynamic backlight is reduced. For example, an RGB value of (127, 0, 0) can be represented by the RGBYMC display by the compensated drive value of (254, 0, 0, 0, 0, 0) (it is for convenience assumed that all numeric drive values are give as 8 bit values i.e. are in the interval of [0,255]). However, this requires that the backlight is at the maximum level.

It will be appreciated that the above example for simplicity and clarity has focused on the reduced luminance capability of a single subpixel. However, in many practical implications it is the more general colorimetrics of the display output which dictate the backlight levels that result in clipping. Indeed, the characteristics may e.g. reflect how intrinsically luminous a certain color is for the human eye for the specific multi-primary characteristics of the display.

In order to reuse functionality from three-primary displays in multi-primary displays, it is desirable to use the same backlight control based on the RGB color signals as e.g. indicated in FIG. 2. However, such an approach would result in the backlight level being reduced to half as it is considered that this still allows the color to be reproduced using the compensated RGB values of (254, 0, 0). However, this clearly results in clipping in the RGBYMC display as it would require higher drive values than 255.

The drive controller 303 of FIG. 3 provides improved performance for a dynamic backlight multi-primary display system while still allowing reuse of many functional blocks from conventional N-primary systems.

The drive controller 303 comprises a receiver 309 which receives a picture signal comprising a set of input N-primary image color defining values for at least one segment of the multi-primary display. The N-primary image color defining values may thus define the color in the N-primary color space of the corresponding pixel. The N-primary image color defining values may correspond to values that could be used to drive an N-primary display directly and may sometimes for convenience be referred to as N-primary drive values. However, in the present example these values are not directly used to drive the display (which is an M-primary display) but rather represent the color of the pixel in the appropriate color space. In the specific example, the N-primary image color defining values may specifically be the RGB values.

Typically, the picture signal comprises image color defining values for all segments of the display but the following description will focus on the application to one such segment. It will be appreciated that the same approach may be applied to other segments. In the example, the input picture signal comprises RGB values. The segment may be chosen freely, but is typically selected as an image area for which the backlight source having a level determined on the basis of the segment is closer/has the lowest light attenuation than for any other backlight source.

The picture signal may be received from any suitable internal or external source.

The drive controller 303 comprises a backlight processor 311 which is arranged to determine suitable backlight levels for the backlight 305. The backlight processor 311 specifically determines a backlight level for each backlight source corresponding to each of the segments.

The drive controller 303 further comprises a drive modification circuit 313 which is arranged to generate a set of modified N-primary image color defining values by adjusting the set of input N-primary image color defining values for the backlight level. Specifically, modified RGB values are generated from the input RGB values.

The drive modification circuit 313 receives the original input RGB values as well as information of the backlight level. In the specific example, the backlight level is provided as a ratio K between the maximum/nominal backlight level and the selected backlight level for the segment:

$$K = \frac{{B}_{Sel}}{{B}_{Max}} .$$

It is furthermore for simplicity initially assumed that the light incident on a pixel of the segment is constant across the segment and is only due to the backlight source associated with the segment. The ratio K thus indicates how much the backlight has been dimmed and accordingly the drive level must be increased by the same factor in order to provide the same light output from the subpixel. Thus, the drive modification circuit 313 may determine the modified RGB values as:

$$\begin{matrix}{R}^{′} = \frac{R}{K} \\ = R \cdot \frac{{B}_{Max}}{{B}_{Sel}}\end{matrix}$$

$$\begin{matrix}{G}^{′} = \frac{G}{K} \\ = G \cdot \frac{{B}_{Max}}{{B}_{Sel}}\end{matrix}$$

$$\begin{matrix}{B}^{′} = \frac{B}{K} \\ = B \cdot \frac{{B}_{Max}}{{B}_{Sel}}\end{matrix}$$

The drive modification circuit 313 thus generates modified RGB values that for the reduced backlight would result in the same light output as the original input RGB values would for a maximum backlight.

The drive modification circuit 313 is coupled to a primary converter 315 which is arranged to convert the set of modified N-primary image color defining values into a set of multi-primary drive values for the M primaries of the multi-primary display 307. Thus, in the specific example, the modified RGB values, i.e. the R′G′B′ values, are converted into six primary drive values RGBYCM.

It will be appreciated that different algorithms for converting between a N-primary color space, such as that of RGB, into an M-primary color space, such as that of RGBYCM, are known to the skilled person and that any suitable algorithm may be used without detracting from the invention.

In the specific example, the conversion is performed based on the XYZ color space reflecting the perceived color by a human. Thus, first the RGB color represented by the input RGB values is in CIE tristimulus values XYZ:

XYZ=M1*RGB,

where XYZ and RGB are column vectors and M1 is a 3×3 matrix with the XYZ primaries of red, green, and blue in the columns, respectively.
The multi-primary display 301 can generate the colors

XYZ=M2*RGBYMC,

where XYZ and RGBYMC are column vectors and M2 is a 3×6 matrix with the XYZ primaries of red, green, blue, yellow, magenta, and cyan in the columns, respectively.

The primary converter 315 then proceeds to solve the mathematical problem of finding the RGBYMC values that result in the XYZ values that are determined for the modified RGB values, R′G′B′.

Several solutions exist to find the multi-primary drive values that produce the desired color XYZ. Typically these solutions scale the input and output gamut to the same value. As previously described, this may result in some colors being outside the multi-primary gamut and thus will not be accurately reproduced. This is typically most pronounced for bright and saturated red, green, and blue primary colors. These colors may accordingly be clipped to the boundary of the multi-primary display gamut or more advanced gamut mapping algorithms may be used that minimize the clipping artifacts. Thus, clipping may occur even for a full backlight due to the maximum light output for a subpixel being reduced for the multi-primary signal.

However, as previously described, the clipping may be exacerbated by the dynamic backlight control as a dimming which may be acceptable in RGB color space may result in clipping in the RGBYMC color space. Thus, the dimming of the backlight based on the RGB color space may result in unnecessary clipping in the RGBYMC color space.

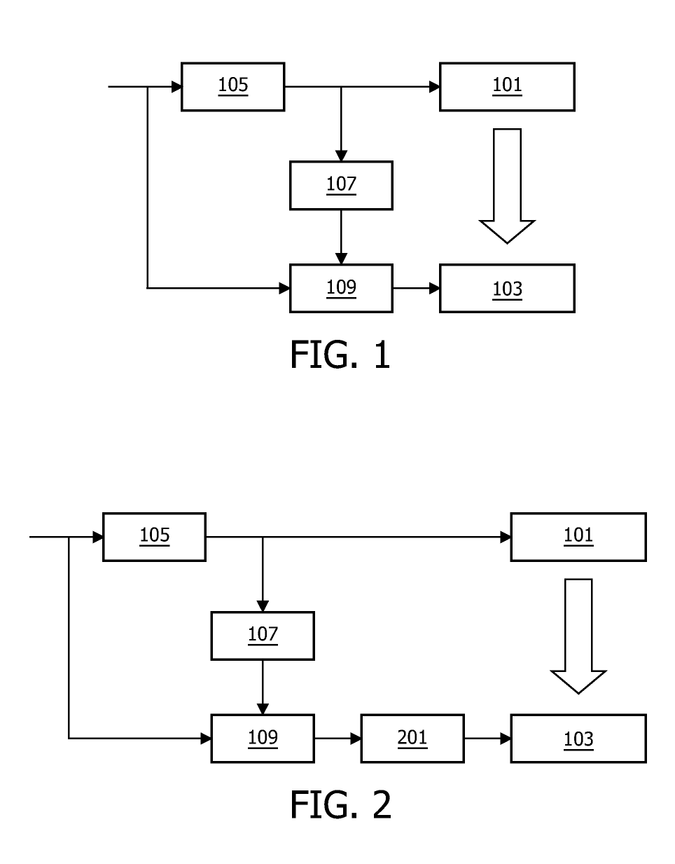

In order to address such issues, the display controller 303 of FIG. 1 does not directly base the backlight dimming on the received RGB drive values but rather performs the backlight dimming determination based on luminance compensated RGB values R″G″B″ that are generated by adjusting the luminance of the input RGB values depending on the chrominance of the pixels.

Note that there can be several ways to compensate input pixel values, e.g. they could depend on a spatiotemporal analysis of the input picture, e.g. a local spatial analysis, which may be useful to take into account the spatial properties of the backlight elements. However, for our invention it is useful if the compensation only depends on the pixel values themselves (and no surrounding information), which can also be seen as a predetermined global transformation (only function of pixel value, luminance and/or chrominance). This can be seen as a size-preserving picture transformation on an input picture also, Preferred embodiments may realize such a global transformation e.g. as a 3-dimensional LUT based on e.g. x, y, L or R, G, B, although mathematical equations implementing the same may be used similarly.

The display controller 303 accordingly comprises a compensator 317 which is coupled to the receiver 309 and the backlight processor 311. The compensator 317 receives the input N-primary image color defining values (i.e. the RGB values) and initially performs a luminance compensation of these to generate compensated N-primary image color defining values, i.e. to generate the compensated R″B″G″ values. These are then fed to the backlight processor 311 which proceeds to determine the backlight level for the segment.

The backlight processor 311 may specifically determine the backlight using the compensated R″B″G″ values as if the display was an RGB display. As a specific example, the backlight processor 311 may proceed to identify the highest value in the segment. Thus, the backlight processor 311 may search through the R″B″G″ values for all the pixels in the segment to identify the highest value. The backlight may then be reduced from the maximum value by a factor corresponding to the ratio between the maximum value and the maximum possible value. Thus, for the 8 bit example where the drive values are in the interval of [0,255], the normalized backlight level (relative to the maximum backlight level) may be determined as:

$$\frac{{B}_{Sel}}{{B}_{Max}} = \frac{N}{255}$$

where N is the maximum identified value. Thus, if the backlight level is reduced to this level, an RGB backlight should be able to produce the desired light output for the subpixel if the maximum drive value is used.

The compensator 317 is arrange to pre-process the input values such that the luminance reducing effect of the multi-primary display relative to a three-primary display is reflected in increased compensated drive values being used for the backlight determination. Thus, the luminance compensation reflects the reduced normalized light output (normalized relative to the maximum light output that can be generated by a pixel, i.e. corresponding to a white signal with all drive values being at their maximum level) that can be generated by a M-primary display relative to the N-primary display. This luminance reduction can cause clipping and is dependent on the chromaticity of the pixel. For example, the light reduction may be very significant for highly saturated colors corresponding to the primaries of the three-primary display, i.e. for saturated red, green or blue colors whereas there may be no light reduction for white pixels. Accordingly, the luminance compensation performed by the compensator 317 is dependent on the chromaticity.

In the example, the compensator 317 performs a luminance compensation of each pixel (i.e. of each RGB set) based on the chromaticity of the pixel. The operation of the compensator 317 may in the specific example be represented by:

R″G″B″=f(x,y)·RGB

where RGB are the input drive values and f(x,y) is a suitable function of the chromaticity represented by the two variables x and y. Thus, the compensated RGB pixels may simply be determined by a scaling of the input RGB values. The same scaling may be applied to each of the values, or in some embodiments (e.g. having differently colored backlights) different scaling of the different colors may be used.

In the example, the function f(x,y) depends only on the chromaticity of the pixel and does not depend on the luminance. Furthermore, it is a static function that can be determined during the manufacturing or design phase or which may be determined and entered during a calibration phase of the display controller 303. Thus, the luminance compensation may be predetermined for each (possible) chromaticity value of the drive values.

The exact luminance compensation as a function of the chromaticity may depend on the specific requirements and preferences of the individual embodiment and may for example depend on the preferred trade-off between clipping and power consumption of the display.

However, in the specific example, the luminance compensation is determined such that clipping is sought to be minimized. This is achieved by determining the luminance compensation for each chromaticity value such that compensation factor is set to the determined (e.g. by analysis or measurement) relative light reduction for a multi-primary pixel relative to a corresponding three-primary pixel.

Thus, the luminance compensation factor may for a given chromaticity be set as the ratio between the luminance for the brightest possible pixel light output (i.e. the maximum drive values) resulting in that chromaticity for the corresponding three-primary display relative to the brightest possible pixel light output (i.e. the maximum drive values) resulting in that chromaticity for the multi-primary display.

Thus for each possible x,y value, the function may be determined as:

$$f ( x , y ) = \frac{{Y}_{RGBYMC} ( x , y )}{{Y}_{RGB} ( x , y )}$$

where Y_{RGBYMC}(x,y) represents the maximum renderable luminance for a pixel with that chromaticity in the RGBYMC display and Y_{RGB}(x,y) represents the maximum renderable luminance for a pixel with that chromaticity in the RGB display.

For example (and for simplicity assuming that all subpixels for all primaries have the same efficiency, and that the human perception has an equal sensitivity for each primary), a pure saturated red may in an RGB display be generated with a luminance which is ⅓ of the total possible luminance output of the pixel. However, for an RGBYMC display, the area of the red sub-pixel is approximately halved and accordingly the maximum luminance for saturated red is only ⅙ of the total possible luminance output of the pixel. Thus, for saturated red, the function takes the value of 2. However, for a white pixel both displays may generate a pixel luminance corresponding to the maximum renderable luminance and thus the function will take the value of 1. It will be appreciated that all values of the function may be determined in this way by analyzing the specific display.

Hence, the function f(x,y) will generally be larger than one resulting in the compensated R″B″G″ values being higher drive values than the input RGB values. However, this increase may exactly reflect the increase in backlight that is required in order to avoid clipping being introduced by the three-primary to multi-primary conversion performed by the converter 315.

Thus, the described approach introduces a low complexity and easy to implement luminance compensation to the input drive values thereby allowing that the functionality for backlight control from a three-primary display can be reused directly without resulting in a significant degradation due to clipping in the multi-primary conversion. Hence, improved performance is achieved while allowing backwards compatibility.

It should be noted that as the function f(x,y) is higher than one, the values may increase above the maximum possible value of the input, and the determined backlight may increase above the backlight corresponding to the maximum RGB levels. In such cases, the backlight may be boosted above the nominal level. If this is not possible, clipping may occur but this clipping is due to the inherent difference in the multi-primary and the three-primary gamuts and will not be exacerbated by the dynamic backlight control.

It will be appreciated that determination of the luminance compensation may be implemented differently in different embodiments.

For example, the compensator 317 may first determine the chromaticity values x,y for the RGB drive values, e.g. by performing the operation:

x=f(R,G,B)=X/(X+Y+Z),

where XYZ is described above as a function of RGB

y=f(R,G,B)=Y/(X+Y+Z),

where XYZ is described above as a function of RGB.

The luminance compensation for the pixel may then be determined by evaluating the function f(x,y) i.e. based on the two chromaticity values.

The function f(x,y) may in many embodiments advantageously be implemented in a look-up table (LUT), and it may be advantageous that such a look-up table is based on only two values rather than the N input values, as this may result in a substantially reduced size of the required look up table and thus a substantially reduced memory requirement.

In some embodiments, it may be more advantageous to evaluate the function by evaluating a mathematical formula. Thus, an equation may be determined that calculates the value f(x,y) when x,y are known. Such an equation may be an approximate equation, such as for example:

$$f ( x , y ) = \frac{1}{1 + s} ,$$

where s=\sqrt{x²+y²}.

In some embodiments, the mathematical formula may be a direct function of the drive values RGB, i.e.:

f(x,y)=y(R,G,B)

In such embodiments, the evaluated function y(R, G, B) may thus include the conversion to the chromaticity representation. Examples of suitable approximate functions may e.g. include:

$$y ( R , G , B ) = \frac{1}{1 + s} ,$$

where s=(max(R,G,B)−min(R,G,B))/max(R,G,B), and typically 0<R,G,B<1.

Thus s correlates with saturation with s=0 being minimal saturation and s=1 being maximum saturation. Hence the scale factor y ranges from 1 to ½. Depending on the luminances of the primaries the formula may be adjusted.

This may allow a highly efficient evaluation and may reduce the memory requirements substantially.

In the previous example, it was assumed that the backlight incident on a given pixel was constant across the segment and only dependent on the backlight source associated with the segment. However, in many practical applications such an assumption may lead to a reduced quality.

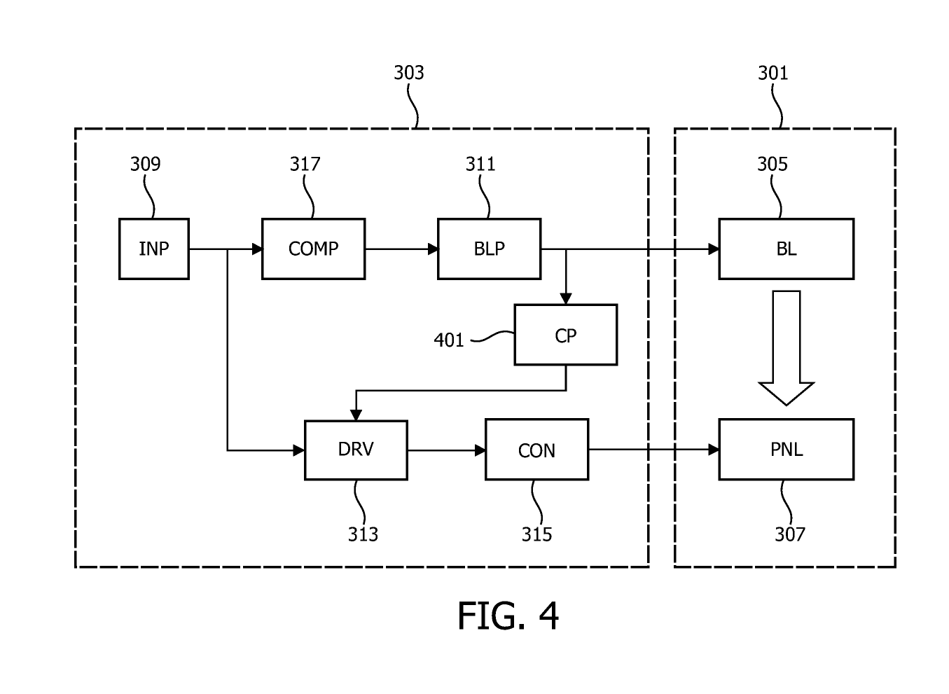

Accordingly, FIG. 4 illustrates an example of the display system of FIG. 3 wherein the display controller 303 has been enhanced to further include a backlight evaluator 401 which receives the determined backlight drive values for all segments and which determines an incident backlight level for each pixel of the segment in response to the backlight level of the associated segment as well as the backlight levels of other segments.

Specifically, for each pixel the backlight evaluator 401 calculates the light that reaches the pixel from each of the backlight sources. This calculation may done be a spatial profiling of the display and specifically the incident light may be determined as the summation of the backlight level of each backlight sources multiplied by the light attenuation from the backlight light source to the pixel. Thus, the incident backlight on a pixel may be calculated by a weighted summation of the backlight levels for each backlight source where the weights are determined based on the geometries of the display and specifically based on the distance between the pixel and the backlight sources. Appropriate weights may specifically be determined during the design and manufacturing phase and may thus be used as predetermined values during operation.

The backlight evaluator 401 thus generates a more accurate indication of the backlight that reaches each pixel. This value is fed to the drive modification circuit 313 which uses this value when determining the modified values. Thus, in this example, the luminance factor applied by the compensator 317 is different than the factor applied to the values by the drive modification circuit 313. However, this approach has been found to provide high quality and allows for low complexity implementation and operation.

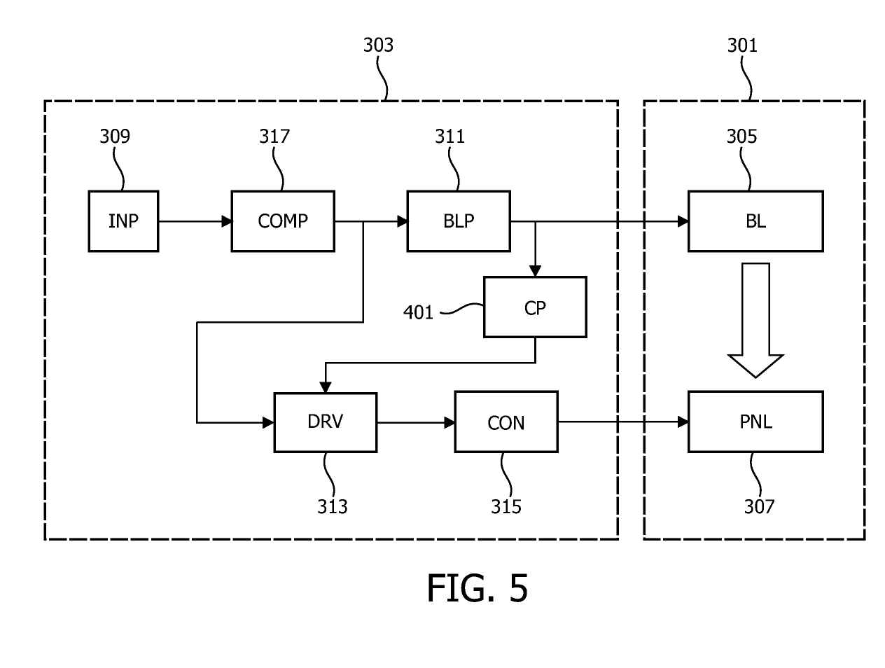

The previous description focuses on embodiments wherein the modified N-primary image color defining values are generated by adjusting the set of input N-primary image color defining values. However, in other embodiments, the modified N-primary image color defining values may be generated by adjusting the set of compensated N-primary image color defining values generated by the compensator 317. An example of such an embodiment is illustrated in FIG. 5 which corresponds to the example of FIG. 4 except that the drive processor 313 receives the modified values from the compensator 317.

In some embodiments, the drive processor 313 is simply arranged to use a modified algorithm that is based on the compensated N-primary values, i.e. the compensation has been taken into account when generating the algorithm. However, in other embodiments, the drive processor 313 may use the same algorithm as for non-compensated values. This may be particularly advantageous in many implementations as it allows existing functionality to be reused. In this case, the controller may include a further compensator which is arranged to take a set of N-primary image color defining values and compensate them for the luminance compensation of the compensator 317. Specifically, if the compensator 317 performs the function f(x,y), the further compensator may perform the function f¹(x,y).

The further compensator may for example be inserted before or after the drive circuit, i.e. it may operated on the compensated N-primary image color defining values fed to the drive circuit or may operate on the modified N-primary image color defining values output by the drive circuit.

In some embodiments, the controller may be arranged such that suitable luminance compensations as a function of pixel chrominance values can be modified or downloaded to the controller. For example, the controller may comprise a memory which stores the relations between chrominance and the appropriate luminance compensation. The memory may for example store this relationship as a function stored in the memory. As another example, the relationship may be stored in the memory as a look-up table that provides the luminance compensation for each set of chrominance values. In these embodiments, the controller may further comprise input means that can receive external data describing relations between chromaticity values and luminance compensation values. This external data can then be used to store suitable relations in the memory. Specifically, the external data may directly comprise data for the look-up table or a suitable function to implement.

Such an approach may provide improved flexibility and adaptability and may allow a device controller to be adapted to provide exactly the performance and operation desired for the individual device. It may thus allow a manufacturing of a single controller type that can later be modified and customized for the specific display. E.g. the approach may allow a generic OEM display controller to be manufactured which can then be customized and adapted by the individual display manufacturer.

It may furthermore allow a more sophisticated control. Indeed, the approach may allow a real time dynamic modification of the pre-compensation values. For example, the pre-compensation values that are used may be modified real time depending e.g. on the type of video signal or content (e.g. whether it is a movie, sport or another category). Indeed, in some embodiments, the data may be included as part of the video content thereby allowing e.g. the content provider to control and determine how the backlight control affects the content.

In the above example it has further been assumed that the backlight is a white backlight. However, the described principles may also be applied to colored backlights where multiple backlights with different spectra may be individually controlled.

For example, for a saturated red image area with a drive value of 128, a conventional color backlight dimming would set the green and blue backlights to zero (off) which will also be acceptable for the multi-primary display. However, a conventional approach would also set the red backlight to half the full value which would lead to clipping. However, using the described approach of pre-compensating, the red backlight would be set to maximum thereby preventing clipping.

More generally it is thus possible to not just perform a scaling of the whole backlight level but rather to perform individual scaling for different colored backlights. For example, more red backlight, would impact on both the red LCD element, the yellow LCD element etc. Thus, rather than a simple scaling, each of the input primary values could be modified individually. Indeed, the effect of one color backlight on the different colors can be decoupled by a suitably generated set of pre-compensation functions/LUTs. This is the case as even without having to do actual multi-primary transformation of all pixels in the image, we know the differently dimmed shapes (e.g. one for each 10% dimming of the different backlight colors) that the display can then make. Thus, it is known where errors occur, and which approximate profile needs to be pre-applied to pre-compensate for this effect.

In some embodiments, the luminance compensation may further be dependent on a luminance characteristic for the segment. For example, the luminance compensation may further depend on whether the segment or whole image is relatively bright or relatively light.

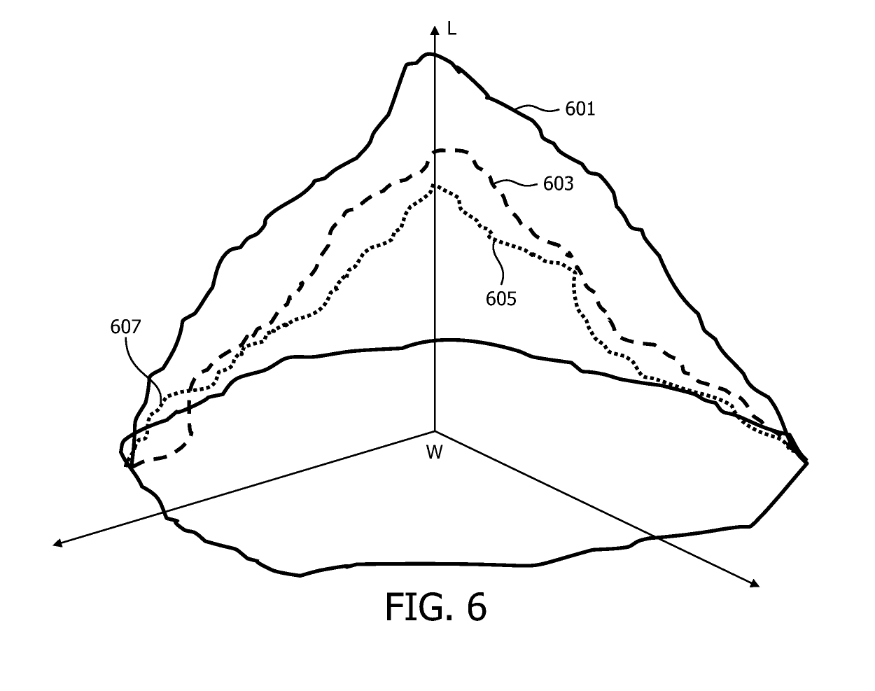

Such an example may for example be demonstrated with reference to FIG. 6 which illustrates a three dimensional color space with luminance in the z-direction perpendicular to a chroma plane. In the figure the different colors/hues are thus spread around in the chroma plane. Further the degree of saturation of the color increases with distance from the central point corresponding to white (w).

In the example, the three dimensional region 601 indicates the maximum gamut of the display, i.e. it corresponds to available gamut for maximum backlight. Thus, the region is defined by maximum backlights and the full range of drive values for the M primary display [0;255] for each of the primary colors.

As the backlight is dimmed, the gamut region is reduced and FIG. 6 illustrates a reduced gamut 603 corresponding to a reduced backlight. It should be noted that the reduced gamut 603 may in some embodiments correspond to a scaling of the maximum gamut 601 but that it more generally may distort in shape as illustrated in FIG. 6. This is typically the case for multi-colored backlights with different dimming of different colored backlights.

FIG. 6 further illustrates the picture gamut 605 of the current picture, i.e. the gamut which is required to be rendered on the display (without introducing any distortion).

As can be seen in FIG. 6, there is at least one problem region 607 where the reduced gamut cannot render the input image whereas the maximum gamut 601 may be able to. As described above, the pre-compensation may allow for this reduced dimming to be avoided.

However, in many embodiments, it may be better to apply a spatial luminance dimming profile rather than apply a global pre-compensation/dimming. Indeed, as it can be determined exactly where the problems occur, it may be possible to only pre-compensate these color values to avoid the backlight dimming to cause clipping. Thus, the pre-compensation may reflect the local characteristics (e.g. the approach may apply a pre-compensating parabola over the saturation plane with a slow roll-off. Such an approach may e.g. allow that unavoidable clipping is reduced and that an increased backlight is focused on the areas where it is specifically required.

In some embodiments, a number of different dimming/pre-compensation profiles may thus be available. For example, the pre-compensation may allow a certain amount of clipping and the pre-compensating function can be generated to determine how much clipping in which parts of the image is allowed. For example, an image analyzer could analyze the artifacts of the first pre-compensating profile. If the result is too severe, the next pre-compensating profile may be applied etc. Indeed, it is possible to continuously update and modify the pre-compensating function. Indeed, it is even possible to allow such pre-compensating functions to be dynamically updated for the specific content being rendered. Thus, the pre-compensating function may be downloaded to the display controller dynamically. This may for example allow a director to create different compensations for artistic creations and effects.

Indeed, it will be appreciated that the approach allows a number of degrees of freedom in the backlight control and the resulting backlight dimming. For example, there are different ways of controlling the backlight using different colors to obtain the desired output color. Such considerations may be reflected in the pre-compensation. As another example, it may be decided to allow some clipping or to render an image darker than prescribed by the input signal. A further degree of freedom is possible by allowing a spatial variation of this backlight control and/or a color spaced variation that allows e.g. some colors to be darkened or clipped but not others.

Note that in principle a single pre-compensation (or at least for white backlighting, for colored backlighting one may want a number of pre-compensations), depending on the chromatic balances of backlighting, e.g. one LUT for each 10% increment combination, e.g. 90% B, 100% R, 100% G) may do, as at least to a certain approximation the rendering problems will be mitigated (typically a trade off between either too many clipping errors, or too little output luminance). However, one may want to tighter optimize the pre-compensation based on the actual image content (the actual image may e.g. not contain any pixel colors in a problem area, in which case dimming could be increased). One may do this be applying a spatial profile, e.g. the upper K DCT blocks of the image are treated with pre-compensation profile/LUT 1 and the lower S-K ones with profile 2. This could be done in complex manners, taking into account e.g. psychovisual severity of clipping artifacts, e.g. based on the underlying image texture. E.g. the controller may start from a first profile (e.g. the one preloaded as default in factory) and then transform/fine tune it into another one by using image content properties from an image analysis module).

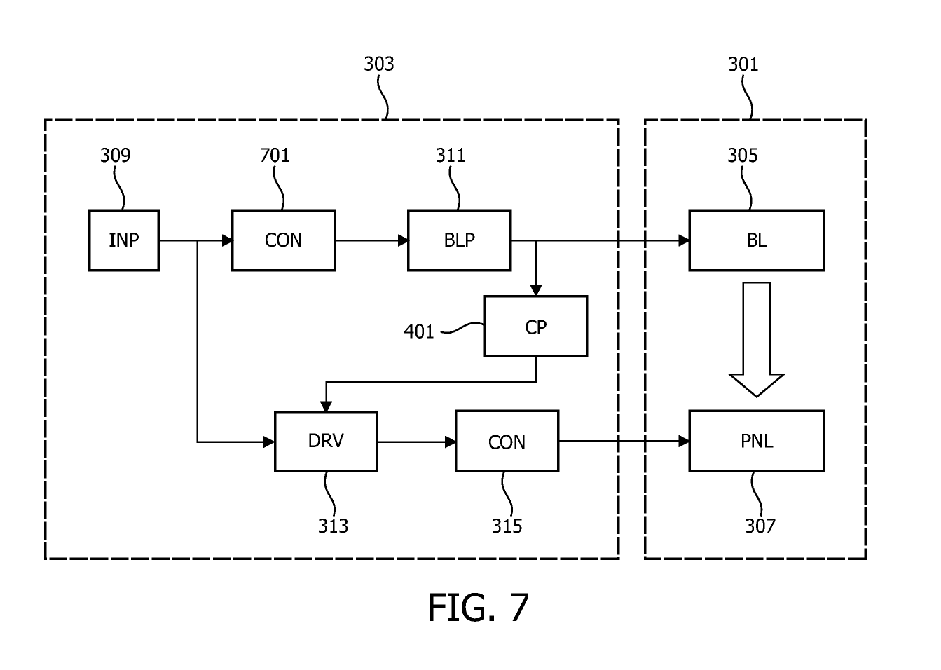

FIG. 7 illustrates another example of a display system with improved performance for a dynamic backlight multi-primary display. The system corresponds directly to the system of FIG. 4 except that the drive controller 303 does not comprise the compensator 317 but instead comprises a primary conversion processor 701.

The primary conversion processor 701 is arranged to convert the input N-primary image color defining values to the multi-primary drive values corresponding to the multi-primary display. Thus, in the specific example the primary conversion processor 701 converts the input RGB values to RGBYCM image defining values. The converted multi-primary values are fed to the backlight processor 311 which proceeds to determine the suitable backlight levels. However, in the system of FIG. 7 the backlight processor 311 determines the backlight level based on the multi-primary values rather than based on the input drive values.

Specifically, the backlight processor 311 may apply the same approach of identifying the maximum value but may in this case extend the search over all six primary values for each pixel. The determined backlight is thus found in the M-primary color space rather than in the input N-primary space thereby ensuring that clipping is not introduced by the dynamic backlight control.

Thus, in the specific example, the display controller 303 first converts the RGB input to a multi-primary output, for example RGBYMC. Then the drive values for the backlight are calculated by determining the maximum of the RGBYMC values instead of the maximum of the RGB values.

This ensures that there will not be introduced more clipping than without dimming. In fact, if a backlight is used that can be boosted, it is possible to prevent all clipping. In this case, the values for RGBYMC may be allowed to be higher than the maximum for the RGB values.

In the example of FIG. 7, the drive controller 303 and primary converter 315 are unchanged relative to the system of FIG. 4. Thus, the driving of the display panel 307 may reuse the same functionality but driven by the different backlight levels generated in the RGBYMC color space.

Thus, in this example, the display controller 303 also comprises the drive processor 313 being arranged generate modified N-primary image color defining values by compensating drive values of the set of input N-primary image color defining values for the backlight level incident on the pixel. This backlight is calculated by the backlight evaluator 401 in the same way as in example 4 but based on the RGBYMC color space determined backlight levels. The primary converter 315 then converts the modified N-primary image color defining values into multi-primary drive values for the primaries of the display panel 307.

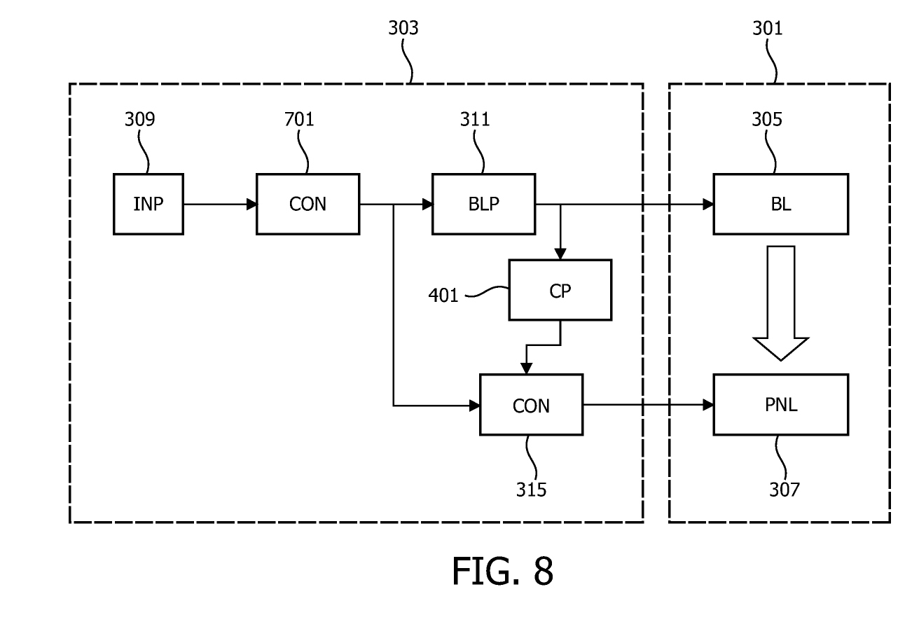

However, in some approaches, the display controller 303 may be modified to only include one primary converter. Specifically, the drive processor 313 may instead of using the original N-primary image color defining values (the input RGB values) use the M-primary values generated by the primary conversion processor 701. In this case, the primary converter 315 may be removed and the drive processor 313 may be modified to operate on the full set of primary values, i.e. on the RGBYMC values in the specific example. The drive processor 315 may specifically perform the same operation on the six RGBYMC values as it performs on the three RGB values in the system of FIG. 4. Such an approach is illustrated in FIG. 8 and may in many embodiments allow a more efficient resource utilization and reduced complexity. However, the system in FIG. 7 may in many embodiments allow increased reuse of existing functionality.

In the systems of FIGS. 7 and 8, the backlight processor 311 is thus arranged to only consider the M-primary drive values, i.e. it does not consider the original N-primary image color defining values.

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. A controller for a multi-primary display employing M>3 primaries, the controller comprising:
a receiver for receiving a first picture signal comprising a set of input N-primary image color defining values, with N>=3, for a segment of the multi-primary display, from which set of N-primary image color defining values M drive values for M primaries for each pixel of the segment can be derived;
a compensator for generating a set of compensated N-primary image color defining values for the segment by applying a luminance compensation to the values of the set of input N-primary image color defining values, the luminance compensation for each pixel of the segment being dependent on a chromaticity of the pixel;
a backlight processor for determining a backlight level for the segment of the display in response to the set of compensated N-primary image color defining values;
a modifier for generating a set of modified N-primary image color defining values by adjusting at least one of the set of input N-primary image color defining values and the set of compensated N-primary image color defining values for the backlight level; and
a primary converter for converting the set of modified N-primary image color defining values into a set of M-primary drive values for the M primaries and generating a M-primary drive signal for the multi-primary display comprising the set of M-primary drive values.

2. The controller of claim 1 wherein the luminance compensation is predetermined for each chromaticity value.

3. The controller of claim 1 wherein the compensator is arranged to convert input N-primary image color defining values for pixels of the segment into two chromaticity values and to determine the luminance compensation for the pixel in response to the two chromaticity values.

4. The controller of claim 3 wherein the compensator comprises a two-dimensional look up table relating values of the two chromaticity values to a luminance compensation.

5. The controller of claim 1 wherein the compensator is arranged to determine the luminance compensation for a pixel by calculating a mathematical formula defining the luminance compensation as a function of the compensated N-primary image color defining values for the pixel.

6. The controller of claim 1 wherein the compensation value for a chromaticity value is dependent on a maximum renderable luminance for the chromaticity value in the gamut of the N primaries relative to a maximum renderable luminance for the chromaticity value in the gamut of the M primaries.

7. The controller of claim 6 wherein the compensation value for a chromaticity value is substantially the ratio between a maximum luminance for the chromaticity in the gamut of the N-primaries and a maximum luminance for the chromaticity in the gamut of the M primaries.

8. The controller of claim 1 wherein the compensator is arranged to increase luminance for at least some chromaticities.

9. The controller of claim 1 wherein all primaries of the M primaries are chromatic primaries.

10. The controller of claim 1 wherein the backlight processor is arranged to determine the backlight level in response to a maximum drive level of the set of compensated N-primary image color defining values.

11. The controller of claim 1 further comprising means for determining an incident backlight level for each pixel of the segment in response to the backlight level and backlight levels of other segments, and wherein the modifier is arranged to generate the set of modified N-primary image color defining values by adjusting drive values of the set of input N-primary image color defining values for each pixel in response to the incident backlight level for the pixel.

12. The controller of claim 1 wherein the modifier is arranged to generate the set of modified N-primary image color defining values by adjusting the set of input N-primary image color defining values for the backlight level.

13. The controller of claim 1 wherein the modifier is arranged to generate the set of modified N-primary image color defining values by adjusting the set of compensated N-primary image color defining values for the backlight level.

14. The controller of claim 13 wherein the primary converter further comprises means for compensating at least one of the set of modified N-primary image color defining values and the set of compensated N-primary image color defining values for the luminance compensation of the drive values of the set of input N-primary image color defining values.

15. The controller of claim 1 wherein the luminance compensation corresponds to a scaling of the drive values of the set of input N-primary image color defining values.

16. The controller of claim 1 further comprising:
a memory for storing a relation between the chromaticity and the luminance compensation; and
input means for receiving external data describing relations between chromaticity values and luminance compensation values and for storing this in the memory.

17. The controller of claim 1 comprising means to receive parameter data for implementing the luminance correction.

18. A display system comprising the display controller of claim 1 and the multi-primary display.

19. A method of controlling a multi-primary display, the method comprising:
specifying at an image creation side of at least one luminance transforming pre-compensation operation for at least one envisaged multi-primary display, and
transmitting to a site of the multi-primary display parametric information specifying this pre-compensation information as a metadata signal correlated with the image signal.

20. A method of controlling a multi-primary display employing M>3 primaries, the method comprising:
receiving a first picture signal comprising a set of input N-primary image color defining values, with N>=3, for a segment of the multi-primary display, from which set of N-primary image color defining values M drive values for M primaries for each pixel of the segment can be derived;
generating a set of compensated N-primary image color defining values for the segment by applying a luminance compensation to the values of the set of input N-primary image color defining values, the luminance compensation for each pixel of the segment being dependent on a chromaticity of the pixel;
determining a backlight level for the segment of the display in response to the set of compensated N-primary image color defining values;
generating a set of modified N-primary image color defining values by adjusting at least one of the set of input N-primary image color defining values and the set of compensated N-primary image color defining values for the backlight level; and
converting the set of modified N-primary image color defining values into a set of M-primary drive values for the M primaries and generating an M-primary drive signal for the multi-primary display comprising the set of M-primary drive values.

21. A controller for a multi-primary display employing M>3 primaries, the controller comprising:
a receiver for receiving a first picture signal comprising a set of input N-primary image color defining values, with N>=3, for a segment of the multi-primary display, from which set of N-primary image color defining values M drive values for M primaries for each pixel of the segment can be derived;
a first primary converter for converting the set of input N-primary image color defining values into a first set of M-primary drive values for the M primaries;
a backlight processor for determining a backlight level for the segment of the display in response to the first set of M primary image color defining values; and
a drive processor for generating a set of modified multi-primary drive values for the M primaries in response to the backlight level for the segment and at least one of the set of input N-primary image color defining values and the first set of M primary image color defining values and generating a multi-primary drive signal for the multi-primary display comprising the set of modified multi-primary drive values.

22. The controller of claim 21 wherein the drive processor is arranged to generate the set of modified multi-primary drive values for the M primaries by compensating drive values of the first set of M primary image color defining values for at least the backlight level for the segment.

23. The controller of claim 21 wherein the drive processor is arranged to generate a set of modified N-primary image color defining values by compensating drive values of the set of input N-primary image color defining values for at least the backlight level for the segment, and to generate the set of modified multi-primary drive values for the M primaries by converting drive values of the set of modified N-primary image color defining values to multi-primary drive values for the M primaries.

24. The controller of claim 21 wherein the backlight processor is arranged to determine the backlight level based on values that only include the first set of M primary image color defining values.

25. The controller of claim 21 wherein the backlight processor is arranged to determine the backlight level in response to a maximum drive level of the first set of M primary image color defining values.

26. A method of controlling a multi-primary display employing M>3 primaries, the method comprising:
receiving a first picture signal comprising a set of input N-primary image color defining values, with N>=3, for a segment of the multi-primary display, from which set of N-primary image color defining values M drive values for M primaries for each pixel of the segment can be derived;
converting the set of input N-primary image color defining values into a first set of M-primary drive values for the M primaries;
determining a backlight level for the segment of the display in response to the first set of M primary image color defining values; and
generating a set of modified multi-primary drive values for the M primaries in response to the backlight level for the segment and at least one of the set of input N-primary image color defining values and the first set of M primary image color defining values and generating a multi-primary drive signal for the multi-primary display comprising the set of modified multi-primary drive values.
